(19) United States
(12) Patent Application Publication
(10) Pub. No.: US 2016/0335914 A1
(43) Pub. Date: Nov. 17, 2016

(54) SYSTEMS AND METHODS OF TRAINING AN INDIVIDUAL TO CUSTOM FIT GOLF EQUIPMENT AND FOR THE RULES OF GOLF

(71) Applicant: KARSTEN MANUFACTURING COPORATION, Phoenix, AZ (US)

(72) Inventors: Oliver Anderson, San Francisco, CA (US); Roger J. Cottam, Mesa, AZ (US)

(21) Appl. No.: 15/204,491

(22) Filed: Jul. 7, 2016

Related U.S. Application Data
(63) Continuation-in-part of application No. 14/152,578, filed on Jan. 10, 2014.
(60) Provisional application No. 62/189,460, filed on Jul. 7, 2015.
(60) Provisional application No. 61/755,671, filed on Jan. 23, 2013.
(60) Provisional application No. 61/751,697, filed on Jan. 11, 2013.

(51) Int. Cl. G09B 19/00; A63B 69/36; G09B 5/12

(52) U.S. Cl. CPC G09B 19/0038; G09B 5/125; A63B 69/36

(57) ABSTRACT

The present disclosure relates generally to training an individual for custom golf equipment fitting and rules of golf, and more particularly, to an education platform to train individuals to custom fit golf equipment and learn the rules of golf.

### CROSS REFERENCE TO RELATED APPLICATIONS

This claims priority to U.S. Provisional Patent Application No. 62/189,460, filed on Jul. 7, 2015, and is a continuation-in-part of U.S. non-provisional application Ser. No. 14/152,578, filed on Jan. 10, 2014, which claims the benefit of U.S. Provisional Patent Application No. 61/751,697, filed on Jan. 11, 2013, and U.S. Provisional Patent Application No. 61/755,671, filed on Jan. 23, 2013, the entire contents of which are fully incorporated herein by reference.

### TECHNICAL FIELD

The present disclosure relates generally to training an individual for custom golf equipment fitting, and more particularly, to an educational platform to train individuals to custom fit golf equipment and for the rules of golf.

### BACKGROUND

For many years, golf equipment has been custom fitted to the unique static and dynamic characteristics of a golfer. Most golf equipment fitting processes involve observational and analytical skills of a golf equipment fitter. The number of variables used to determine the “best” fit and the variability of golfers may present a challenge.

The ability to train individuals by utilizing different levels of learning is important for memorizing facts, recognizing certain issues, and applying the memorized facts to the uniquely identified issue. By teaching on different levels of interactivity and consciousness, a golf equipment fitter can retain the knowledge in an almost instinctual manner. In the field of custom fitting golf equipment, time may be limited, and there may be many distractions and variables in the custom golf-fitting environment. Both the golfer and the golf equipment fitter may greatly benefit from an instinctual like process that takes less time, and is more accurate and consistent.

In contrast to the “one-size-fits-all” approach golf fitting, a custom fitting process may provide a golfer with more effective golf equipment. In particular, the golfer may interact with a golf equipment fitter, who takes certain measurements of the golfer including both static and dynamic measurements (e.g., height, wrist-to-floor distance, hand length distance, etc.).

Accordingly, the golf equipment fitter may use his or her knowledge and expertise to recommend the proper golf equipment for the golfer.

Some systems and methods of training individuals to custom fit golf equipment may involve classroom-like activities including reading, lectures, quizzes, etc. In particular, a golf equipment fitter may be given a linear learning experience with large amounts of information to memorize. These systems and methods may not address the challenge in keeping an individual engaged while embedding information into his or her memory. Additionally, the ability to memorize the information does not necessarily translate to the application of the memorized information in a real custom fitting session for golf equipment.

Each golf governing body, such as the United States Golf Association, has created rules of golf that consist of a standard set of regulations and procedures by which the sport of golf should be played and prescribe penalties for rule infractions. The rules of golf are published by golf governing bodies on a regular basis. The publication may also include code of conduct (i.e., etiquette) and terminology definitions. To proficiently learn the rules, an individual has to carefully and methodically study the entire publication, which is voluminous, to be able to apply the rules to any situation on the golf course. In addition, an individual has to learn to quickly find a rule in the publication that applies to a particular situation.

### BRIEF DESCRIPTION OF THE DRAWINGS

FIG. 1 depicts a visual representation of virtual landmarks associated with an educational platform.

FIG. 2 depicts a block diagram of one example of an educational golf-fitting tier.

FIG. 3 depicts a block diagram of one example of an educational platform.

FIG. 4 depicts a block diagram of another example of an educational golf-fitting tier.

FIG. 5 depicts a visual diagram of one example of an educational platform.

FIG. 6 depicts a block diagram of one example of an educational platform.

FIG. 7 depicts a block diagram of one example of an educational tier.

FIG. 8 depicts an example screenshot of a gamified educational experience.

FIG. 9 depicts an example display of a leaderboard.

FIG. 10 depicts an educational platform according to one embodiment.

FIG. 11 depicts block diagram of an educational platform.

FIG. 12 depicts a block diagram representation of an example client device in accordance with the methods, apparatus, systems, and articles of manufacture described herein.

FIG. 13 depicts a visual representation of a system associated with an educational platform as described herein.

FIG. 14 depicts a block diagram representation of an example server device in accordance with the methods, apparatus, systems, and articles of manufacture described herein.

### DESCRIPTION

In general, systems and methods for training an individual to custom fit golf equipment are described herein. The methods, apparatus, systems, and articles of manufacture described herein may provide an educational platform for training an individual to custom fit golf equipment (e.g., a knowledge management system). The educational platform may include information relating to the process of custom fitting golf equipment, games, challenges, assessments and feedback presented in a tiered fashion. The educational golf fitting tiers may be associated with various levels of expertise regarding custom fitting golf equipment. As a result, the educational platform may train an individual to custom fit golf equipment in a progressive, interactive, and effective manner.

The methods, apparatus, systems, and articles of manufacture described herein may incorporate a targeted and progressive educational platform including a plurality of educational golf fitting tiers associated with golf fitting expertise levels. In general, the methods, apparatus, systems, and articles of manufacture described herein may provide golf equipment fitters with a multi-tiered, interactive learning experience. The educational platform described herein may result in more efficient custom golf equipment fitting experiences for golfers.

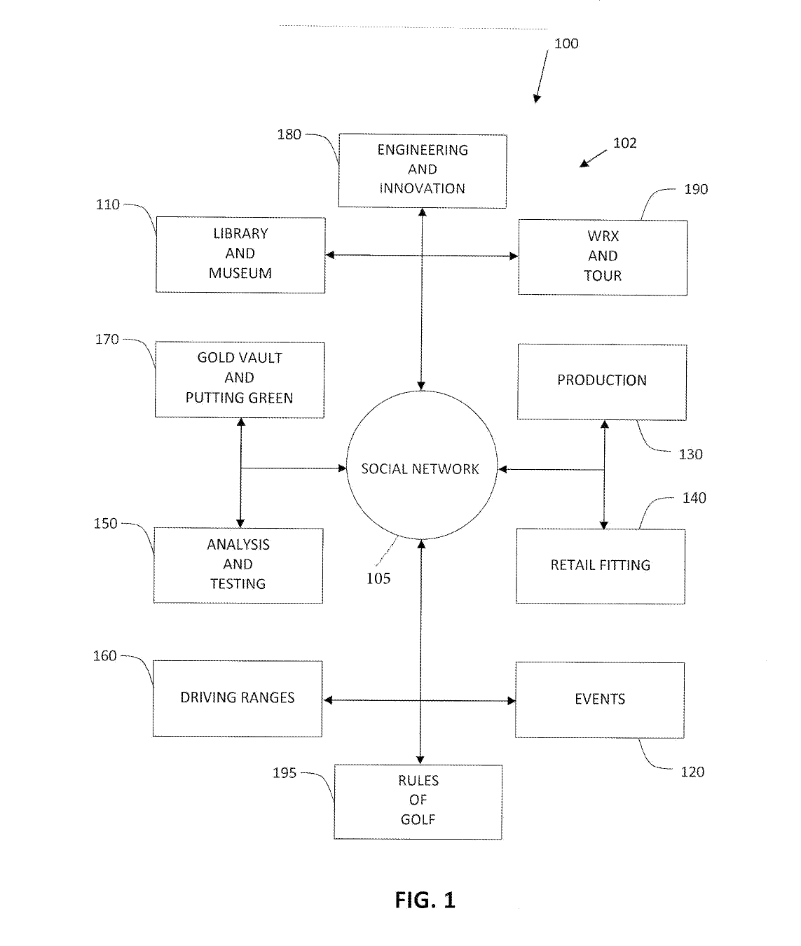

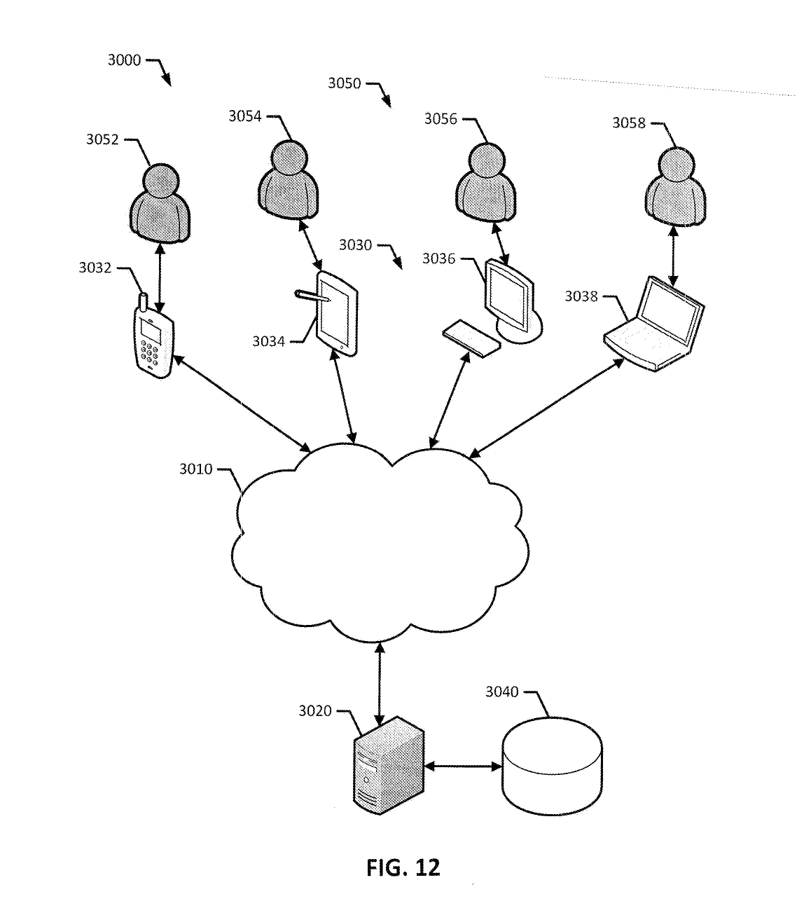

One embodiment of an educational platform 100 is shown in FIG. 1. The educational platform 100 may be accessible in the form of a gamified experience as shown in FIG. 1. The gamified experience may be a virtual experience or a board game experience. Access to the educational platform 100 may be presented in the form of a geographic location containing a plurality of landmarks 102 where an individual or a golf equipment fitter (e.g., one shown as 3052 of FIG. 12) may access the educational activities associated with custom fitting golf equipment (e.g., generally shown as blocks 105, 110, 120,130, 140, 150, 160, 170, 180, and 190). The plurality of landmarks 102 may help the individual 3052 associate with a golf equipment brand and products of that particular brand.

For example in FIG. 1, the social network landmark (block 105) may allow an individual 3052 (e.g., one shown as 3052 in FIG. 12) to interact with other individuals (e.g., shown as 3054, 3056, and 3058 of FIG. 12) or fictional characters who participate in educational activities associated with custom fitting golf equipment. Other landmarks may include various educational activities containing unique subject matter as described in detail below.

The individual 3052 may access any of the plurality of landmarks 102 and the corresponding educational activities. Additionally, the plurality of landmarks 102 may contain educational activities, which may be revisited for each golf fitting expertise level achieved by the individual 3052.

Also depicted in FIG. 1 is a library and museum landmark 110 that may represent a “knowledge bank” accessible by the individual 3052. The library and museum landmark 110 may include any type of current or archival file, publication, video, or any other suitable reference materials. The library and museum landmark 110 may also include relevant information to assist the individual 3052 in completing the educational activities contained in the plurality of landmarks 102.

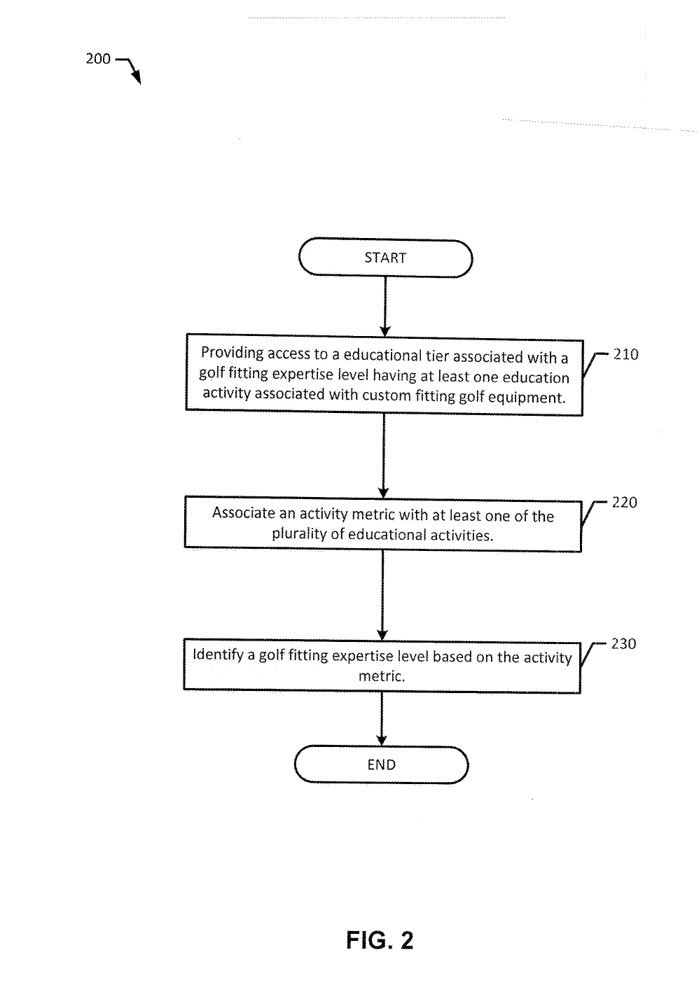

Turning to FIG. 2, for example, the educational platform 100 may operate in accordance with a process 200. In general, the process 200 may provide access to a plurality of educational tiers with each educational tier being associated with a golf fitting expertise level (block 210). In particular, the process 200 may provide access to at least one educational activity associated with custom fitting golf equipment.

As an individual 3052 accesses the educational activities, the process 200 may associate an “activity metric” with the educational activities (block 220). All or some of the educational activities accessed in the process 200 may be associated with the activity metric. Based on the activity metric, the process 200 may identify a golf fitting expertise level (block 230).

The educational platform 100 may be comprised of performing a single iteration of the process 200, or comprised of repeatedly accessing the process 200 in a cyclical or concurrent manner. By accessing the process 200 in a cyclical manner, a progressive education platform 100 may be provided, which presents tiers of educational information based on progressive golf fitting expertise levels. For example, if an educational activity with a predetermined difficulty level is completed by the individual 3052, the next educational activity may increase in difficulty. However, if the educational activity is unsuccessfully completed by the individual 3052, the next educational activity may be lower in difficulty to promote a progressive learning experience for the individual 3052.

Various methods may be used to provide the individual 3052 access to the educational platform 100. One method of providing an individual 3052 access may be by providing a written document with instructions for access. For example, an individual 3052 may receive a post card, a facsimile, or a letter describing how to access an educational tier. In another example, the individual 3052 may access the educational platform 100 through any digital media such as e-mail, text message, web link, social network platform, and/or any other digital communication.

With access to the educational platform 100, the individual 3052 may interact with the educational tiers by accessing educational activities. An educational tier may include a single, comprehensive educational activity such as a lecture, publication, or a puzzle for the individual 3052 to complete. Alternatively, an educational tier may include many educational activities. The educational activities may present any subject matter associated with a custom fitting experience.

The education platform 100 may include one or a plurality of educational tiers. Each educational tier may include one or more educational courses with each course including one or more lessons. Each course and/or each lesson may be associated with one or more educational activities corresponding with the landmarks 102 or other educational landmarks associated with golf related products or golf fitting. A course and/or a lesson may be associated with one, some or all of the educational activities corresponding to the landmarks 102. Alternatively, each course and/or each lesson may be associated with only one of the landmarks 102. Each lesson and/or course may represent a level of expertise in golf fitting. Accordingly, when an individual 3052 successfully complete a lesson and/or course, his or her level of expertise in golf fitting moves up one level. Each educational tier may represent a degree in golf fitting (e.g., first degree, second degree and third degree).

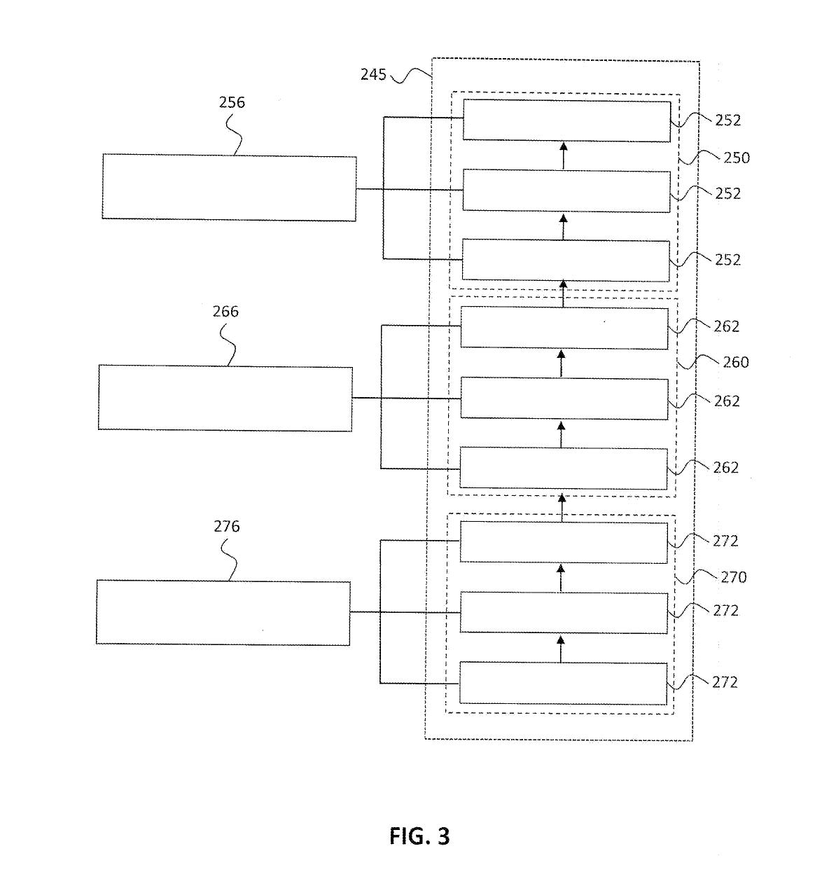

According to one embodiment shown in FIG. 3, an educational platform may include three educational tiers 250, 260 and 270. Each of the educational tiers 250, 260 and 270 may include a plurality of courses 252, 262 and 272, respectively, with each course having a plurality of lessons (not shown). An individual engaging the educational activities of the educational platform can progressively increase his or her knowledge and/or skills by gamification of the individual's learning experience. The educational platform includes a database of information or a domain of knowledge 245 from which courses and or lessons obtain educational material to increase an individual's knowledge and/or skills with respect to or more specific knowledge and/or skill areas. Specific areas of knowledge and/or skill may include problem solving skills, declarative and factual knowledge, conceptual knowledge, rule based knowledge, procedural knowledge, soft skills, affective knowledge, and psychomotor skills. Declarative and factual knowledge is knowledge that can only be learned through memorization. Conceptual knowledge is knowledge about ideas, events, or objects that have a common attribute or a set of common attributes. Rules based knowledge is knowledge that expresses the relationships between concepts, indicating cause-and-effect and if/then relationships. Procedural knowledge is the knowledge of step-by-step instructions for performing a particular task. Affective knowledge deals with attitudes, interest, values, beliefs, and emotions. Soft skills knowledge includes personality traits, social graces, communication, language, personal habits, friendliness, and optimism that characterize relationships with other people. Psychomotor knowledge covers the intersection of physical skills and cognitive skills. Each of the educational tiers, the courses and/or the lessons of the educational platform may include gamified educational activities that increase an individual's knowledge and skills with respect to one or more of the above-noted specific areas of knowledge and/or skill associated with golf fitting.

A first educational tier 250 may include courses 252 that increase the knowledge of an individual 3052 with respect to one or more golf related brands and products marketed and sold under those brands. The first educational tier 250 may include, for example, courses that increase an individual's declarative and factual knowledge and/or skills and/or conceptual knowledge and/or skills. Each course 252 may include a plurality of lessons (not shown). Successfully completing each lesson and/or each course moves the individual up one level in golf fitting knowledge or expertise associated with the first educational tier. An individual 3052 who satisfactorily completes the first educational tier 250 may become an expert with respect to the one or more golf related brands and the products marketed and sold under those brands. The individual 3052 may then be awarded a product expert certification and/or a badge 256. The product expert certification and/or badge 256 may represent a first degree of expertise in golf fitting.

The individual 3052 may then advance to the second educational tier 260, which may include courses 262 that increase the knowledge of the individual 3052 with respect to golf fitting. The second educational tier 260 may include, for example, courses that increase an individual's conceptual knowledge and/or skills, procedural knowledge and/or skills, soft skills knowledge and/or further rule based knowledge and/or skills. Each course 262 may include a plurality of lessons 264. Successfully completing each lesson and/or each course moves the individual up one level in golf fitting knowledge or expertise associated with the second educational tier. An individual 3052 who satisfactorily completes the second educational tier 260 may become a golf fitting expert at least with respect to the products associated with the first educational tier 250. The individual 3052 may then be awarded a fitting expert certification and/or badge 266. The fitting expert certification and/or badge 266 may represent a second degree of expertise in golf fitting.

The individual 3052 may then advance to the third educational tier 270, which may include courses 272 that further increase the knowledge of the individual 3052 with respect to golf fitting. The third educational tier 270 may include, for example, courses that increase an individual's affective knowledge and/or skills, psychomotor skills, and/or or problem solving skills. Each course 272 may include a plurality of lessons 274. Successfully completing each lesson and/or each course moves the individual up one level in golf fitting knowledge or expertise associated with the third educational tier. An individual 3052 who completes the third educational tier 270 may become a golf fitting master at least with respect to the products associated with the first educational tier 250. The individual 3052 may then be awarded a master fitting certification and/or badge 276 The master fitting certification and/or badge 276 may represent a third degree of expertise in golf fitting.

Referring back to FIG. 1, for example, educational activities may be associated with various subject matters such as custom fitting golf equipment (e.g., the retail fitting landmark 140), product branding (e.g., the gold vault and putting green landmark 170), manufacturer's history (e.g., library and museum landmark 110), golf ball flight tracking (e.g., driving range landmark 160), new golf equipment technology or software (e.g., engineering and innovation landmark 180), equipment quality assurance (e.g., analysis and testing landmark 150), and rules of golf according to one or more golf governing organizations (e.g., rules of golf landmark 195). Other embodiments may include any, all, or other subject matters.

The educational activities may be accessible by an individual 3052 with a digital device such as a desktop computer, laptop computers, handheld computer, tablet computer, portable media player (e.g., an IPOD® mobile digital device from Apple Inc., Cupertino, Calif.), wireless telephone (e.g., an IPHONE® mobile digital device from Apple Inc., Cupertino, Calif.), global positioning system (GPS) device, game console device, digital camera, video camera, and/or other processor-based device. When accessing the educational platform 100, the individual 3052 is presented with a virtual interactive area having objects representing landmarks associated with each educational activity. According to one embodiment, the interactive area may be graphically simulated as a campus (hereinafter referred to as the “virtual campus”) having a plurality buildings, where each building represents a landmark associated with certain educational activity or other activities associated with the educational platform 100. The virtual campus may be graphically simulated in a three-dimensional format so that the individual 3052 can visually identify landmarks shown in the display and navigate through the virtual campus with a sense of realism. Each building on the virtual campus may have one or more signs or indicators that convey to the individual 3052 the educational activities associated with that building. Alternatively, the individual 3052 may refer to a map or directory to identify the buildings. When an individual 3052 accesses the education platform 100, he or she may be presented with an aerial view of the virtual campus or a map of the virtual campus. If presented with an aerial view, the individual 3052 can then navigate to a building and either select the building or enter the building to engage in the educational activities associated with that building. If presented with a map view of the virtual campus, the individual 3052 can select a building to engage in the educational activities associated with that building.

According to one embodiment, after a landmark or a building is selected, the individual 3052 may be presented with a virtual simulation of the interior of the building and/or the educational activities associated with the building. For example, selecting a building may entail the individual 3052 virtually entering the building through a front door or a gateway. After the individual 3052 enters the building, he or she can view the interior of the building, which may include graphically simulated walls, compartments, rooms, hallways and/or other interior spaces, through which the individual 3052 can navigate. Each room may be associated with one or more educational activities and/or one or more achievement levels for a certain educational activities. For example, the engineering and innovation landmark 180 may be represented on the virtual campus with a building having either a certain configuration that can be associated with the function of that building or simply a sign that indicates the function of the building (e.g., a sign on the building that reads “Engineering & Innovation”). Each building may be associated with the course, while each room in the building may be associated with a lesson for the course. After the individual 3052 selects and/or enters the landmark 180, 3D virtual representation of the interior of the building may be displayed to the individual 3052. According to one embodiment, the interior of the landmark 180 may include compartments, rooms, hallways, and/or other interior spaces associated with engineering and innovation educational activities. For example, the interior of the building may have virtual rooms associated with science and technology related to golf clubs, software related to golf clubs and/or the game of golf, science and technology related to stroke analysis, golf ball flight analysis, golf club aerodynamics, golf club center of gravity analysis and golf club moment of inertia analysis. After an individual 3052 enters the building, he or she may be presented with a virtual display depicting the lobby of the building, from where the individual 3052 can view rooms and or compartments associated with the noted educational activities. The individual 3052 can then either select a room or compartment associated with the educational activity or navigate through the building to reach a room having the selected educational activity.

Generally, the activity metric measures the interaction of the individual 3052 with the educational platform 100. The activity metric may be based on right or wrong answers to questions, time spent on lessons or lectures, a confidence level entered by the individual 3052 reflecting his or her confidence in the presented subject matter, scores in games, the number of time the individual 3052 accesses the educational platform 100, or any other suitable measure of educational activities.

The activity metric may provide a base for identifying a golf fitting expertise level. For example, a golf fitting expertise level may be a novice or beginner level, a competent level, a proficient or experienced level, an expert or professional level, or a master or elite level based on the activity metric of the individual 3052. In another example, the golf fitting expertise levels may be numeric, alphanumeric, geometric, and/or color levels. While the above examples may describe multiple golf fitting expertise levels, the methods, apparatus, systems, and articles of manufacture may include a single golf fitting expertise level.

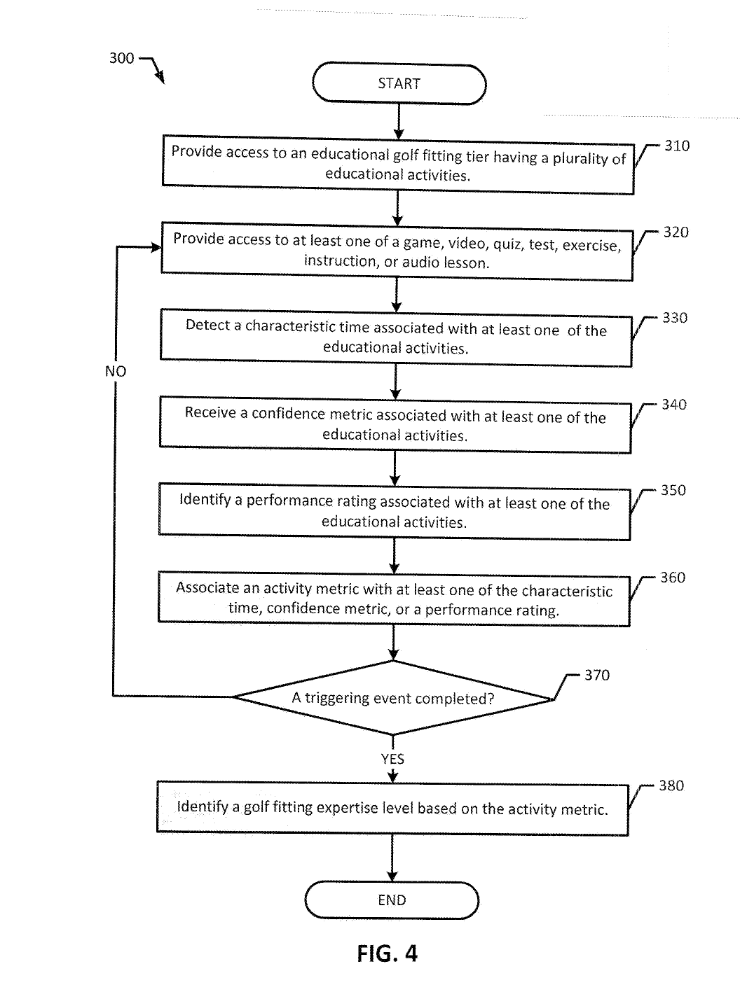

In FIG. 4, for example, a process 300 may associate the activity metric with a plurality of variables from the educational activities. The process 300 may have any number of educational activities and any number of associated variables.

Access to process 300 is provided to an individual 3052 through any of the methods described above, and then the individual 3052 may interact with the educational activities provided (block 320). Blocks 330, 340, and 350 contain variables that may be associated with the activity metric and educational activities. An educational platform 100 may have any, all, or some of the processes depicted in blocks 330, 340, and 350. Additionally, the order of blocks 330, 340, and 350 may change as needed depending on the educational activity being associated with the activity metric.

While an individual 3052 is accessing the educational activities within process 300, there may be a characteristic time measured that is associated with the educational activity (block 330). The characteristic time may be a measure of the time it takes the individual 3052 to complete a quiz or question. Alternatively, the characteristic time may be the time it takes the individual 3052 to find an object in a search game or a matching game. Further, the characteristic time may be associated with the amount of time an individual 3052 spends reading a publication or listening to a lecture. The characteristic time can be associated with any temporal measure of an individual's interaction with educational activities or educational tiers.

The process 300 may receive a “confidence metric” associated with a confidence rating entered by the individual 3052 (block 340). For example, after the individual 3052 interacts with an educational activity, he or she may be asked to rate him or herself regarding his or her confidence in his or her own knowledge of the subject matter contained in an educational activity or educational tier.

The confidence rating may be associated with the confidence metric in block 340. For example, if the confidence rating is a non-numeric rating (e.g., “poor”, “good”, “excellent”, etc.), then the confidence rating may be associated with a numeric confidence metric. In another example, the confidence rating may be numeric, and directly proportional to the associated confidence metric.

In the process 300, an educational activity may be associated with a performance rating (block 350). The performance rating may be based on identifying a correct or incorrect answer to one or more questions. Alternatively, the performance rating may be based on a predetermined difficulty level assigned to the educational activity. For example, a relatively higher-difficulty level question may be associated with a value of ten (10) in response to a correct answer whereas a relatively lower-difficulty level question may be associated with a value of one (1) in response to a correct answer. In another example, the performance rating may be associated with the amount of time the individual 3052 takes to answer a question or to complete a task in addition to a predetermined difficulty level and/or a right or wrong answer.

According to one embodiment, the activity metric may include points awarded to an individual 3052. An individual 3052 may be awarded points when engaging in and progressing through an educational activity. The points awarded to an individual 3052 may be referred to herein as experience points. An experience point is a unit of measurement that may be used to quantify the progress of an individual 3052 through a lesson in an educational tier, a course in an educational tier, and/or an educational tier in the educational platform 100. Experience points may be awarded when an individual 3052 finishes and/or satisfactorily completes a certain portion of a lesson, the entire lesson, a certain portion of a course, the entire course, a certain portion of an educational tier, and/or the educational tier. Awarding experience points to an individual may also depend on the speed by which the individuals recalls information, the individual's memory of information, and/or the level of engagement of the individual in the educational activity (e.g., the individual's attention when engaged in an educational activity). Awarding experience points may also depend on how frequently the individual returns to engaging with the educational platform. For example, the individual may be awarded a certain number of experience points every time he or she logs into the educational platform to engage in an educational activity. Additionally, an individual may be awarded experience points by controlling other game opponents or individuals that are engaged in the educational activity. For example, when an individual is engaged in a gamified educational activity with one or more other individuals as described herein, he or she may create challenges for the other individuals and accordingly receive experience points. Furthermore, experience points may be accumulated throughout an individual's use of the educational platform and may be used by the individual 3052 to enhance the individual's experience using the educational platform as further described herein.

Associating the activity metric with the educational activities (block 360) may include one or more of blocks 330, 340, and 350. The activity metric may be associated with an educational activity through one or more measurements, values, inputs, and/or rewards provided by the educational activities. In the process 300, the activity metric may include a characteristic time, a confidence metric, and/or a performance rating. However, any suitable data, information, metric, or value associated with an educational activity may include the activity metric.

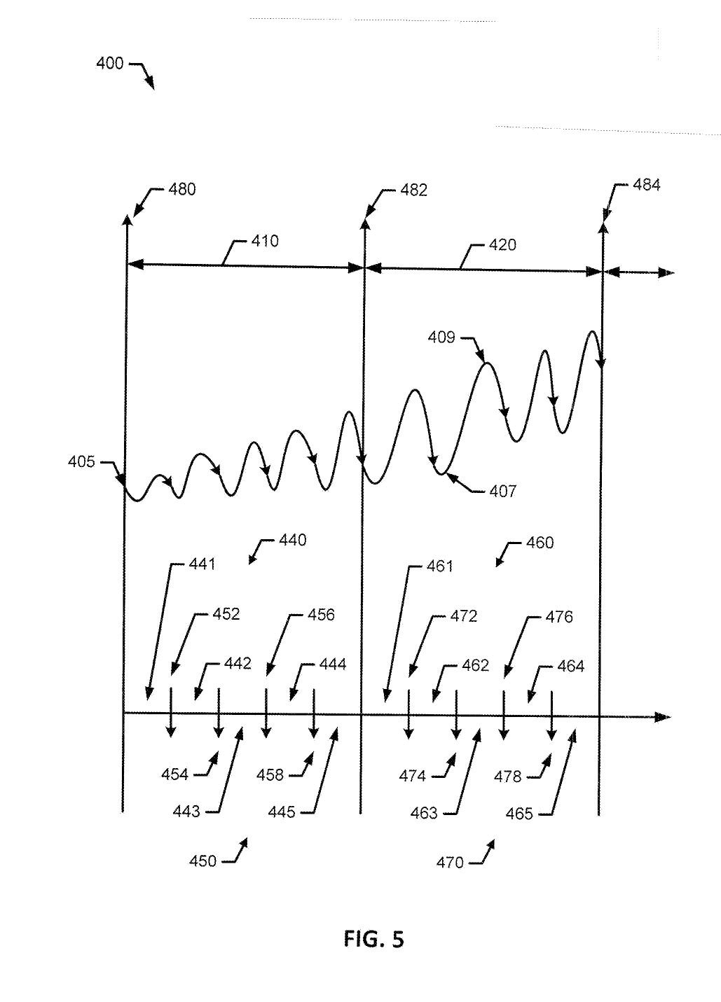

Further, the activity metric or an educational activity may be associated with a triggering event (e.g., generally shown as 450 in FIG. 5) (block 370). If the activity metric or an educational activity creates a triggering event, the individual 3052 may access another educational activity, educational tier, or golf fitting expertise level. The triggering event may be associated with a predetermined threshold.

According to one example, a triggering event may be one or more quizzes and/or one or more examinations administered to an individual 3052 upon finishing a lesson, a course and/or an educational tier. Each quiz and/or examination may be administered to the individual 3052 as a gamified experience as described in detail herein. If an individual 3052 meets a certain threshold with respect to one or more quizzes and/or examinations, the individual 3052 may then be granted access to another lesson, course, educational activity, educational tier, and/or special golf fitting expertise level. The threshold for a triggering event may be, for example, the individual's performance on one or more quizzes and/or examinations meeting a certain score or point value. The threshold for a triggering event is further described herein.

The individual 3052 may interact with a plurality of educational activities to associate an activity metric with a triggering event. Alternatively, not all educational activities may be considered a triggering event when completed successfully by the individual 3052. For example, an individual 3052 may engage in educational activities associated with the library and museum landmark 110. Such engagement may entail, for example, the individual 3052 reading current and/or archival articles and/or watching informational videos related to a brand of golf equipment, a certain player, and/or subjects associated with golf science and technology. Such activities, however, may be initiated by the individual 3052 to satisfy his or her desire for knowledge in a particular area rather than to complete an educational activity associated with an educational tier. According to one embodiment, an individual may visit a company that manufactures golf equipment so that he or she can learn about the company's products. The individual may earn a badge (e.g., mission badge) for such a visit that may not be considered a triggering event. However, the individual may be awarded certain number of experience points for the visit.

The individual 3052 may also engage in off-line learning, i.e., not engaging the educational platform 100, but earning badges as a result of his or her off-line learning. For example, an individual can attend a certain off-line event, which may be a tradeshow, a seminar, a tour, or a trade conference. The individual may then earn one or more badges and be awarded certain experience points for attending the off-line event. The badges and/or experience points may be awarded by the sponsor and/or the organizer of the event through various modes of communication. For example, the individual may use his smart phone to communicate with a smart phone of the organizer of the event through one or more modes of short range wireless communication to receive badges and/or experience points from the organizer of the event.

If the activity metric or educational activities are not associated with a triggering event, the individual 3052 may return to the educational activities (block 320) to further interact with the educational activities of process 300. If the activity metric or educational activity is associated with a triggering event, then the individual 3052 may access other educational activities.

In response to the individual 3052 achieving a triggering event, the process 300 may identify a new golf fitting expertise level (block 380). The golf fitting expertise level identified may be associated with an activity metric and/or educational activities completed. The golf fitting expertise level may be any of the expertise levels discussed herein, or any suitable identifier associated with the activity metric.

In some embodiments depicted in FIG. 5, the educational platform 100 may include a plurality of educational tiers 400. The individual 3052 may be provided with access to an educational tier based on the activity metric associated with prior completed educational activities. The educational tier may have a predetermined value or mark that the activity metric must meet before the individual 3052 may be allowed to access it through a triggering event. Alternatively, an educational activity may be associated with a triggering event that allows an individual 3052 access to an educational tier. In general, the triggering events may trigger progression within the educational platform.

Turning to FIG. 5, for example, an access pathway 405 may visually represent the level and progress of the individual 3052 through a plurality of educational tiers 400 of the educational platform 100 (generally shown as 410, 420, and 430). For example, access to the educational platform 100 may begin on the left (e.g., the educational tier 410 may be the first educational tier accessed by the individual 3052) and progress towards the right (e.g., the educational tier 430 may be the third educational tier accessed by the individual 3052).

The first educational tier 410 may include a plurality of educational activities 440, generally shown as 441, 442, 443, 444, and 445, and a plurality of triggering events 450, generally shown as 452, 454, 456, and 458. The second educational tier 420 may include a plurality of educational activities 460, generally shown as 461, 462, 463, 464, and 465, and a plurality of triggering events 470, generally shown as 472, 474, 476, and 478. The plurality of educational activities 440 and 460 may or may not be similar. Likewise, the plurality of triggering events 450 and 470 may or may not be similar.

The vertical axes, generally shown as 480, 482, and 484, may represent the difficulty level of the plurality of educational activities 440 and 460 of the educational platform 100 at any given point along the access path 405. In one example, the vertical axis 480 may represent the beginning of the first educational tier 410 whereas the vertical axis 482 may represent the end of the first educational tier 410. In another example, the vertical axis 482 may represent the beginning of the second educational tier 420 whereas the vertical axis 484 may represent the end of the second educational tier 420. The vertical axis 484 may represent the beginning of the third educational tier 430. As the individual 3052 progresses through the first educational tier 410, the access pathway 405 may climb higher relative to the vertical axes 480, 482, and 484, which may signify an increase in difficulty, an increase in the number of achievements, or an increase in the golf fitting expertise level of the individual 3052. Alternatively, the vertical axes 480, 482, and 484 may represent an individual's level of achievement and/or mastery of the subject matter contained at any given point of the educational platform 100.

The access pathway 405 may extend through the first educational tier 410 from left to right as the individual 3052 completes the plurality of educational activities 440 and achieves the plurality of triggering events 450. For example, the individual 3052 may be provided with a video, publication, or game as an educational activity 441. Then the individual 3052 may be presented with a question, quiz, or challenge as the triggering event 452. The individual 3052 may proceed to the educational activity 442 when the individual 3052 completes the trigger event 452. Upon completion of the educational activity 442, the individual 3052 may be presented with the trigger event 454.

The access pathway 405 may oscillate as shown in FIG. 5, which represents a relatively instantaneous measure of the progress of the individual 3052 through educational platform 400 (e.g., the progress through one educational activity 441 and one triggering event 452). Although the more instantaneous progress along access pathway 405 is oscillatory (e.g., access pathway 405 may be comprised of localized minimums and maximums), the cumulative result of the oscillation of access pathway 405 may signify an overall increase in golf fitting expertise, achievement or difficulty throughout educational platform 400.

For example, when the individual 3052 first accesses a video or publication at educational activity 462, the individual's golf fitting expertise level or achievement relative to that video or publication may be at a localized minimum 407. This is because the subject matter may be new to the individual 3052, or more detailed than the individual 3052 has previously learned. As the individual 3052 progresses to a quiz or exam at triggering event 467, the golf fitting expertise level and achievement relative to that subject matter may increase until a quiz or exam is successfully completed at the local maximum 409 of the access pathway 405.

The access pathway 405 may progress through a plurality of educational activities 440 and a plurality of triggering events 450 in the educational tier 410. Another golf fitting expertise level may be identified that is associated with the plurality of educational activities 460 and educational tier 420. The new golf fitting expertise level being relatively higher on axis 480 as depicted in the educational platform 400.

The access pathway 405 may then provide access to the educational tier 420 comprised of a plurality of educational activities 460 and a plurality of triggering events 470. Further, the access pathway 405 may lead to educational tier 430 after the individual 3052 has completed and achieved a sufficient number of the plurality of educational activities 460 and the plurality of triggering events 470 in the educational tier 420.

The individual 3052 may receive an academic badge for completing an educational activity. For example, the individual 3052 may receive a first badge for completing the educational activity 441 and a second badge for completing the educational activity 442. The individual 3052 may also receive an academic badge for completing each trigger event. For example, the individual 3052 may receive a badge for completing the trigger event 452.

In addition to receiving badges, the individual 3052 may also accrue points (e.g., experience points) for an educational activity and/or a trigger event. Based on the number of points, the individual 3052 may be placed on a leaderboard relative to other individuals 3050 participating in the education platform 100.

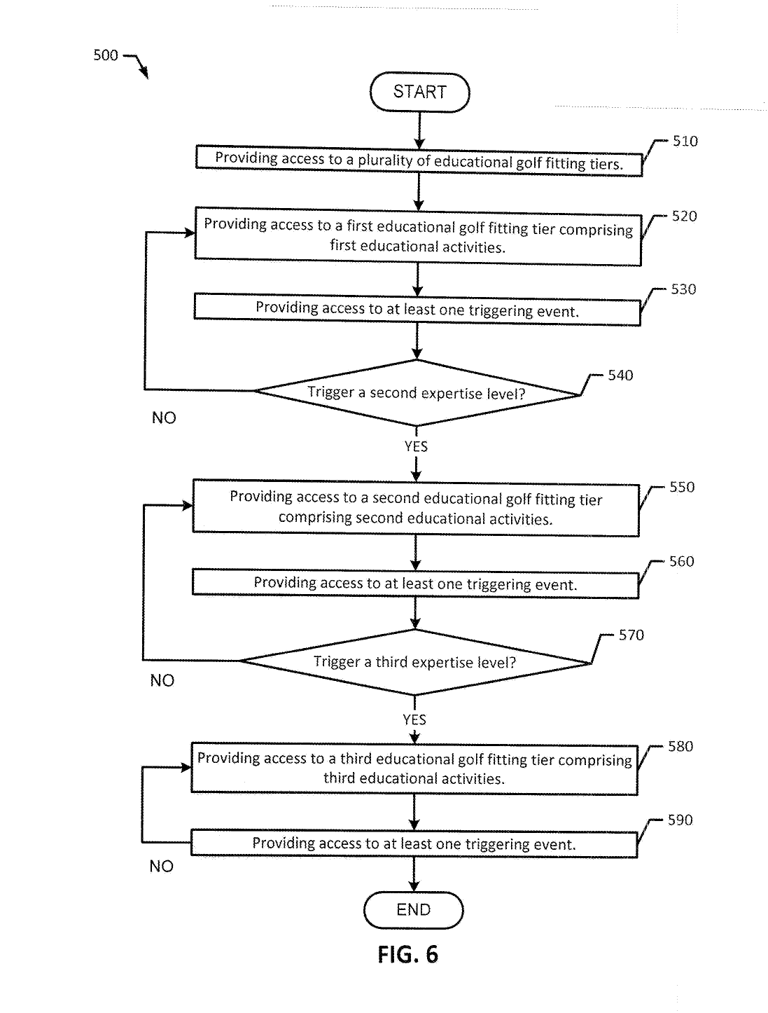

An exemplary process 500 is shown in the block diagram in FIG. 6. The process 500 may begin with providing the individual 3052 with access to the first educational golf-fitting tier 410, which includes the plurality of educational activities 440 (block 520). The educational tier 410 may be similar to the first educational tier 250 of FIG. 3. The plurality triggering events 450 may be accessed based the educational activities 440, or based on an activity metric associated with the plurality of educational activities 440 (block 530). For example, if a triggering event 450 is not achieved (e.g., the activity metric is insufficient or the educational activity was incomplete), then the individual 3052 may return to the educational activities 440 of educational tier 410 (decision block 540).

If all triggering events 450 are achieved, the individual 3052 may be given access to the educational tier 420, which may include a plurality of educational activities 460 and a plurality of triggering events 470 (blocks 550 and 560). The educational tier 420 may be similar to the second educational tier 260 of FIG. 3. In response to the individual 3052 achieving completing the plurality of educational activities 460 and achieving the plurality of triggering events 470, the process 500 may provide access to the educational tier 430 to the individual 3052 (block 570). The educational tier 430 may be similar to the third educational tier 270 of FIG. 3.

Turning back to FIG. 5, one example of the educational platform 400 will be described. Educational tier 410 may have a golf fitting expertise level of “sales associate” associated with it, and may provide golf equipment brand training in the form of educational activity 441. An exam may be provided for the triggering event 452 that is related to the company brand training. The brand training may be related to a golf equipment manufacturer, and may involve company history, goals, or services. If individual 3052 passes the exam triggering event 452 then the individual 3052 may accumulate points.

The next educational activity 442 may relate to golf equipment training. The golf equipment training may involve information about both hard goods (e.g., golf clubs) and soft goods (e.g., golf bags). After completing the golf equipment training, individual 3052 may take an exam triggering event 454. If the individual 3052 passes the exam triggering event 454, the individual 3052 may accumulate more points. The individual 3052 may then be provided a custom golf equipment fitting educational activity 443 that involves fitting technologies and tools. Then another exam triggering event 456 may be completed by the individual 3052, and more points can be accumulated.

A final exam triggering event 458 that covers all educational activities 440 in educational tier 410 may then be accessed by the individual 3052. After passing the final exam, the individual 3052 may access educational tier 420 that has a golf fitting expertise level (e.g., FIG. 6 block 540) of an “aspiring fitter.” Educational tier 420 may then provide educational activities 470 based on more brand training, golf equipment training, and custom golf equipment fitting training. Educational tier 420 may also provide exam triggering events 460 so the individual 3052 may further accumulate points. After triggering events 460 are passed, the individual 3052 may progress to another educational tier that has a golf fitting expertise level of “professional fitters.”

Educational platform 400 may continue with any number of educational tiers and any number of golf fitting expertise levels. Additionally the educational tiers may include any number of educational activities and triggering events; and the subject matter is not limited to brand training, product training and fitter training.

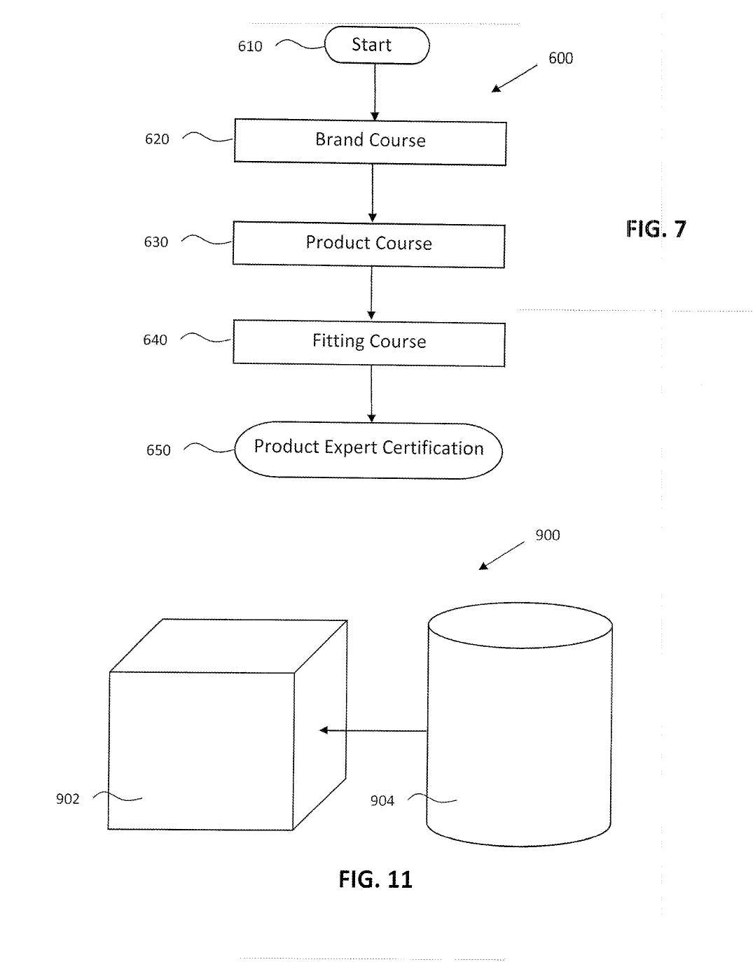

Referring to FIG. 7, an example of the educational tier 410 is shown. The educational tear 600 may be similar to the educational tier 410 or any other educational tier as described herein. The educational tier 600 includes a brand course 620, a product course 630 and a fitting course 640. However, the number of courses included in the educational tier 600 may not be limited to the courses described herein. Each course may include a plurality of lessons as shown in the example of FIG. 3. For example, the educational tier 600 may include a total of 31 lessons with 11 lessons in the brand course 620, 17 lessons in the product course 630, and 3 lessons in the fitting course 640. The brand course 620 may include an educational program for teaching an individual 3052 about different brands of golf related products that the individual 3052 may be marketing, promoting or selling. For example, the brand course may teach the individual 3052 about the history of a certain company, the corporate structure of the company, and/or the evolution of the products of the company. The product course 630 may include an educational program for teaching the individual 3052 about the different golf related products associated with the brands covered in the brand course 620 and similar or other golf related products from competitive brands. The fitting course 640 may include an educational program for teaching the individual 3052 about basic considerations when fitting golf related products to an individual 3052 (i.e., a customer, a client, etc.). The noted examples of the contents of each course is exemplary and does not limited in any way the material that can be covered in the educational tier 600.

Before engaging in the educational tier 600, an individual 3052 may have to start the educational tier 600 by registering with educational platform 100 to provide his or her information (i.e., individual profile) to the educational platform 100 to create a new player account. The individual 3052 may create his or her individual profile at start 610. The individual profile may include information such as login information, the individual's name, age, experience, education, location of employment, golf experience, golf handicap, knowledge of certain products, favorite products, and/or any other information that may assist the educational platform 100 in creating customized educational tiers for the individual 3052. Registration with educational platform 100 may be required only when an individual 3052 is engaging with educational platform for the first time. After the initial registration with educational platform 100, the individual 3052 may simply login to that special platform and continue from where he or she left off. The individual 3052 has the option of changing his or her individual profile, customizing the gamified educational experiences provided by the educational platform 100, providing feedback regarding completed lessons, courses and/or completed educational tiers, and/or registering for certain competitive campaigns with other individuals (such as individuals 3054, 3056 and 3058). To encourage an individual 3052 to complete his or her individual profile as best as possible, experience points may be awarded to the individual 3052 for providing as much information in his or her individual profile as possible. Based on the individual profile provided by an individual 352, the educational platform 100 may configure the educational tiers to better suit the individual 352 to maximize the individual's learning and retention of information.

To engage in the brand course 620, the product course 630, or the fitting course 640, the individual can access the virtual campus as described above. The brand course 620 may be accessible by the individual navigating to and entering a brand course building or landmark (not shown in FIG. 1). Similarly, the product course 630 may be accessible by the individual navigating to and entering a product course building or landmark (not shown in FIG. 1). Similarly, the fitting course 640 may be accessible by the individual navigating to and entering a fitting course building or landmark shown in FIG. 1). Thus, although not shown in FIG. 1, each building or landmark on the virtual campus as described herein may be associated with a particular course, where the rooms are compartments in the building are present at least one lesson in that particular course.

Successful completion of the educational tier 600, i.e. successful completion of the brand course 620, the product course 630 and the fitting course 640 earns an individual 3052 a product expert certification 650 and/or a first degree badge. Each lesson may include one or more interactive video presentations, after which an individual 3052 can take a quiz to assess his or her learning of the materials presented in the lesson. However, the lessons may not be limited to interactive video presentations and may include any type of teaching tool. Upon satisfactory performance of the individual 3052 on the quiz, the individual 3052 levels up or a level of expertise of the individuals is increased. For example, if the individual was at level 22 before successfully completing a lesson, after completing the lesson the individual will be at level 23. The individual can then proceed to the next lesson in the course. Satisfactory performance of the individual 3052 may be based on the number of quiz questions the individual 3052 answers correctly. For example, letter grades can be assigned to the individual's performance such as a letter grade of C for answering 70-79% of the questions correctly, B for answering 80-89% of the questions correctly, A for answering 90-99% of the questions correctly, and A+ for 100% or answering all of the questions correctly. The individual 3052 may also earn a badge after satisfactory completion of each quiz. For example, the letter grade of C earns the individual 3052 a bronze badge, a letter grade of B earns the individual 3052 a silver badge, a letter grade of A earns the individual 3052 a gold badge, and a letter grade of A+ earns the individual 3052 a gold plus badge. Each of the noted badges may also earn the individual 3052 a certain number of experience points.

After the lessons in each course are satisfactorily completed, the individual 3052 may be presented with a course exam covering some or all of the lessons (e.g., a comprehensive exam) in that course. Upon satisfactory performance of the individual 3052 on the exam, which may be based on the same evaluation and grading system as described above, the individual 3052 may level up and earn a badge. The badge for completion of each course may have a higher value than the badges awarded for completing each of the lessons in that course. For example, if a badge for completing a lesson and receiving a grade of A+ is worth 5 experience points, the badge for completing a course and receiving a grade of A+ may be worth 25 experience points.

An individual may view is badges, keep track of his experience points, and/or view any parameter associated with the activity metric by visiting the vault landmark 170 of the virtual campus. For example, the individual 3052 can navigate to enter the vault landmark 170 and enter one or more rooms to view the above noted activity metrics.

After the courses in each educational tier are satisfactorily completed, the individual 3052 may be presented with a comprehensive exam covering some or all of the lessons and/or courses in that educational tier. Upon satisfactory performance of the individual 3052 on the exam, which may be based on the same evaluation and grading system as described above, the individual 3052 may earn a badge. Furthermore, the individual obtains the degree for completing the educational tier. The badge for completion of each educational tier may have a higher value than the badges awarded for completing each of the lessons and each of the courses in that educational tier. For example, if a badge for completing a lesson and receiving a grade of A+ is worth 5 experience points and a badge for completing a course and receiving a grade of A+ is worth 25 experience points, the badge for completing an educational tier and receiving a grade of A+ may be worth 100 experience points.

When an individual completes an educational tier, he or she receives the degree that represents his or her level of expertise according to the completed educational tier. The individual may be issued a certificate that may be in hard copy form or electronic to indicate his or her accomplishment. The certificate may include individuals name in the degree achieved. The certificate may include augmented reality markers to enable an individual or others to view more information about the individual and his or her accomplishments by activating an augmented reality software on a portable computing device such as a smart phone. For example, an individual can view the certificate through the camera lens of his or her smart phone. The augmented reality software that is installed on the smart phone then detects the augmented reality marker on the certificate and activates an argument in reality display of the certificate. The augmented reality display of the certificate may show further information about the individual his accomplishments in the educational platform in the form of text, graphics, photos, videos, and/or a combination thereof. The information may include the individual's experience points, his or her badges, campaigns or competitions that the individual has won, the levels accomplish in the educational platform, the individual's rank on one or more leader boards, and/or any other information associated with the individual's engagement with the educational platform.

While the above example may describe three educational tiers, the methods, systems, apparatus, and articles of manufacture described herein may include more or less than three educational tiers. Further, the methods, systems, apparatus, and articles of manufacture described herein may have any number of educational activities and triggering events associated with each of the plurality of educational tiers.

In some embodiments of the educational platform 100, at least one of the educational activities may be a virtual fitting activity. The virtual fitting activity may allow an individual 3052 to virtually fit an avatar or character for custom golf equipment over a computer network. The virtual fitting activity may include both dynamic and static measurements of a virtual customer. The measurements may be entered manually by the individual 3052 or through a data-gathering device such as a camera and/or a motion sensor.

The virtual fitting computer network may be a gaming console, a computer, a smart device, and/or any other suitable digital apparatus. The virtual fitting activity may further be gamified to include obstacles such as thieves, criminals, or fire drills. The virtual fitting activity may be associated with a characteristic time or a confidence metric.

In one embodiment of the educational platform 100, some of the educational activities may be augmented reality educational activities. The individual 3052 may be provided with a physical target for accessing an augmented reality educational activity when the physical target is viewed through a digital device such as a smart phone (e.g., one shown as 3032 in FIG. 12).

For example, the individual 3052 may view a badge or a textbook through a digital device accessing an augmented reality environment where a virtual character may be fit for custom virtual golf equipment. The virtual character may have a predetermined golfing style that the individual 3052 can analyze to supply the virtual character with the most appropriate custom virtual golf equipment. The virtual character may require a putter of a certain length and suited for certain stroke type, and the individual 3052 is given several putters to choose from in the augmented reality environment. When the correct putter is selected, the augmented reality educational activity may be associated with the activity metric (e.g., block 360 of FIG. 4).

Another embodiment of an augmented reality educational activity may include a “find-it” type game. For example, the individual 3052 may view a badge or text book through a smart device. The find-it may entail the individual using a certain means of transportation to move around in a simulated virtual environment, such as a golf course, to find certain objects. The individual may move around in the virtual environment with for example, the hot air balloon, a ground vehicle, or simply by walking. When the individual 3052 has accomplished the find-it game an activity metric (e.g., block 350 of FIG. 4) may be associated with the performance of the individual 3052.

Any of the educational activities, quizzes and/or exams as described herein may be configured as a gamified experience. An individual 3052 may use a desktop computer, laptop computer, handheld computer, tablet computer, portable media player (e.g., an IPOD® mobile digital device from Apple Inc., Cupertino, Calif.), wireless telephone (e.g., an IPHONE® mobile digital device from Apple Inc., Cupertino, Calif.), global positioning system (GPS) devices, game console device, digital camera, video camera, other processor-based device, and/or any other suitable digital apparatus to engage in gamified educational activities. The gamified activities may include one or a plurality of role-playing games, fantasy or trilogy games, racing games, puzzles, sports games, shooting games, board games, trivia games, simulation, or any other virtual gaming experience.

The effectiveness of educating an individual 3052 with a gamified experience may depend on the archetype of the individual 3052. Accordingly, the types of games used in a gamified experience for each individual 3052 may be determined based on the archetype of the individual 3052 so that learning and information retention is maximized. Before and individual 3052 engages in an educational activity, the archetype of the individual 3052 may be determined so that a gamified experience that suits that individual 3052 is provided to the individual 3052 during the educational activity.

An individual 3052 who wishes to engage in the educational activities described herein may be associated with one of four groups based on his or her archetype. The first group may include individuals who do not care about winning the game unless it means beating someone else, and those who gauge their impact on other players as more important than their engagement with the game. The first group may be referred to as the “Killers” group. Games such as first-person shooter games may be suitable for individuals in the Killers group. The second group may include individuals who strive to be at the top, gain status and show everyone else their status, do not stop until they achieve their goal, and only engages in activities that helps them reach their goal. The second group may be referred to as the “Achievers” group. Games such as racing games or sports competition games may be suitable for individuals in the Achievers group. The third group may include individuals who enjoy connecting with others through the game environment, where the game is merely a backdrop to the individual's inclination or wish to socialize with others. The third group may be referred to as the “Socializers.” Trivia games may be suitable for individuals in the Socializers group. The fourth group may include individuals who wish to accumulate knowledge and to share the knowledge with others, and enjoy the discovery of learning new things that others do not know. The forth group may be referred to as the “Explorers”. Games such as treasure hunts may be suitable for individuals in the Explorers group.

Before an individual 3052 engages in an educational activity, his or her archetype may be assessed to determine in which of the above four groups the individual 3052 may belong. After the individual's archetype is assessed, a gamified educational activity configured for the group in which the individual 3052 belongs is presented to the individual 3052. The archetype of the individual 3052 may be assessed by presenting him or her with a plurality of questions, answers to which can determine the individual's archetype. Alternatively, the individual 3052 may be allowed to play games in each of the above for groups. Based on the preferences of the individual 3052 for certain games, a determination can be made as to the archetype of the individual 3052. After the archetype as the individual 3052 is determined, the individual 3052 is provided with the gamified experience according to one of the above-described four archetype groups corresponding to the individual's archetype. Certain individuals may have combination archetypes such that their archetypes fit two or more of the above-described archetypes. For such individuals, hybrid gaming experiences may be used to maximize their learning. For example, an individual may be provided with a game that has both the elements of first-person shooter game and trivia game because the individual's archetype may fit in both the Killers group and the Socializers group.

An example of a type of game that may be used for an individual 3052 whose archetype fits within the Killers group will now be described. The game includes a digital golf karting game having customizable content (both recreational and educational), and different levels of play or accomplishment. The game may be referred to herein as the golf karting game. The golf karting game may be played on any digital device as described herein. The setting for the game is a virtual golf course having a number of holes, with each hole having a number of hazards or obstacles, targets, other virtual opponents or carts, and/or challenges. The opponents may also include friends or other actual individuals who can play the same game through a local or global communications network to play the game. An individual 3052 drives the golf cart through the golf course by using physical or virtual controls on the digital device to accomplish various timed or untimed tasks such as defeating virtual opponents, engaging in challenges, avoiding hazards or obstacles, driving toward and hitting various targets and/or accomplishing other tasks associated with the game.

Accomplishing each task in the game may involve information being presented to the individual 3052 and/or the individual 3052 being tested on his or her knowledge of such information before the individual 3052 is allowed to continue with the game. Thus, while the individual 3052 is focused on winning the game, a large amount of information may be peripherally or passively processed by the individual 3052, which may greatly enhance the individual's learning of the information and retention of the information. The game may also have various levels of difficulty with respect to gameplay and/or educational content. The difficulty may correlate with the difficulty of the educational tear. Accordingly as an individual 3052 progress through various levels, he or she can learn more difficult subject matters and/or previously learned subject matters in more detail while still enjoying the gaming environment.

An example of a type of game that may be used for an individual 3052 whose archetype fits within the Achievers group will now be described. The setting for the game is a virtual golf course having a number of holes, with each hole having a number of hazards or obstacles, targets, and/or challenges. The game may be referred to herein as the labyrinth golf game. The game is scalable and may be played on any digital electronic device such as a computer, laptop, tablet, smart phone, game console or any electronic device having a display and controls for manipulating objects on the display.

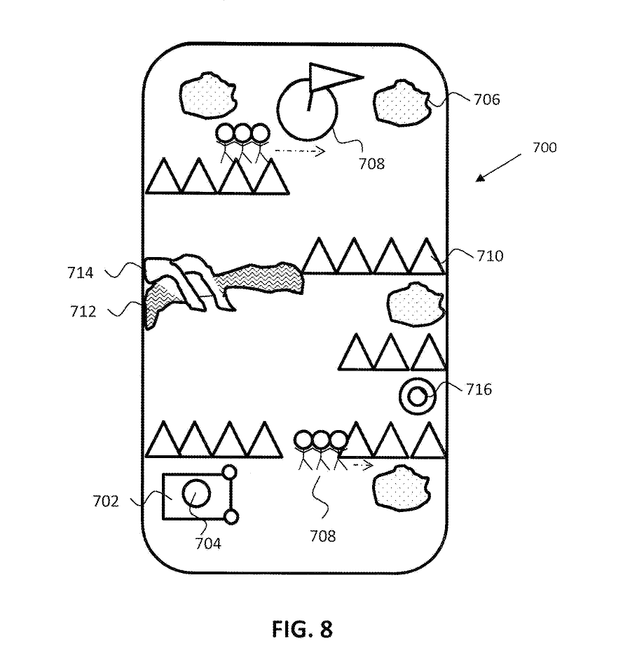

Referring to FIG. 8, an exemplary screenshot 700 of the labyrinth golf game is shown. The screenshot 700 shows a two-dimensional virtual golf hole having a tee box 702, a golf ball 704, the plurality of hazards such as bunker hazards 706, golf crowd 708 (moving in the direction of the arrows shown in FIG. 8), trees 710, a water hazard 712, and a drawbridge 714, a trigger 716 for opening the drawbridge, and a scoring cup 718. The drawbridge 714 remains open, i.e., cannot be used, unless the trigger 716 is activated. However, once to trigger 716 is activated, the drawbridge stays closed for a few seconds. The noted visual components of the screenshot 700 are exemplary and do not limit the various objects that may be displayed on the screenshot 700 and interacted with by an individual 3052 during gameplay. Furthermore, each virtual golf hole may be displayed to an individual 3052 in a three-dimensional format. The individual can then navigate through the three-dimensional virtual golf course in different directions and have a perspective view of the virtual golf course.

The object of the game is to navigate the golf ball 704 from the tee box 702 into the scoring cup 718 as fast as possible, while trying to avoid the bunker hazards 706, the golf crowd 708, the trees 710, and the water hazard 712 in order to avoid losing time and adding strokes. Furthermore, the individual 3052 must navigate the golf ball 704 onto the trigger 716 to open the drawbridge 714 and then quickly navigate the golf ball 704 over the drawbridge 714 before the drawbridge 714 opens. Each time the golf ball 704 enters one of the hazards, the individual 3052 may be presented with educational information in the form of questions, which the individual 3052 must answer in order to continue playing. Thus, while engaged in the labyrinth golf game, an individual 3052 may be presented with a large amount of information and retain the information because of the gamification of the learning experience.

Individuals who play the labyrinth golf game can challenge their friends in competitions or play in campaign challenges. Furthermore, individuals can customize the content of the game (questions, answers, and feedback) that will be experienced during game play. Additionally, individuals can also customize which portions of the game, such as which game holes, to select in determining their learning assessment.

The labyrinth game may include a plurality of golf holes that progressively become more difficult based on course layout and/or puzzle mechanics. The layout of the holes may also depend on seasonal factors, products for which the individual 3052 is engaging in the educational activity, or other factors, which may be controlled by the individual 3052 or an administrator such as an employer of the individual 3052. Getting the golf ball 704 from the tee box 702 into the scoring cup 718 may be timed to provide a more challenging gameplay, control the level of difficulty of the game, pressure an individual 3052 to accomplish game tasks faster, and/or delete test the speed by which an individual 3052 can recall learned information.

The golf labyrinth game and/or any of the gamified educational activities described herein may have one or more feedback mechanisms. For example, the labyrinth golf game may have two avatars or game characters that assist an individual 3052 with the game. One avatar may be a motivator who may be based on a character recognized by the individual 3052 is a celebrity, role model or anyone who can provide the individual 3052 with encouragement to continue playing the game. The avatar of the motivator may model a golf professional or a golf celebrity. The motivator may encourage the individual 3052 to perform better in both the game and educational activity. For example, the motivator may cheer an individual 3052 when the individual 3052 answers a question correctly. The expert avatar may appear when the individual 3052 requires assistance during a lesson or makes a mistake in answering a question. The expert avatar may provide additional information regarding the lesson or assist the individual in better understanding the concepts covered in the lesson.

To play the labyrinth game, an individual 3052 may either download the game onto his or her digital device or play the game online. For example, the individual 3052 can download the game into his or her smart phone to play the game. The motion of the golf ball 704 may be controlled by moving the smart phone or using physical or virtual controls on the smart phone. For example, for smart phones that have accelerometers and/or other types of motion and position sensors, the individual 3052 can simply tilt the smart phone to move the golf ball 704 in the direction of the tilt.

Before playing the game, the individual 3052 can select the seasonal and/or educational content, i.e., educational content for which he or she wishes to play the game. The individual 3052 can also select from a variety of golf courses for playing the game. Each golf course may have a particular theme and may be made up of nine golf holes, with some of the holes being easy holes, some being medium difficulty holes and some being difficult holes. The difficulty of the golf course and/or the holes of the course may directly correlate with the difficulty of the educational activity, i.e. questions, quizzes and/or exams to satisfy a certain triggering event. However, the difficulty of the golf course and/or the holes of the course may not correlate with the difficulty of the educational activity.

As described above, when an individual 3052 enters a hazard, he or she must answer one or more questions correctly before he or she is allowed to continue with the game. The question may appear in a pop-up window on the display screen of the digital device. If the individual 3052 answers a question incorrectly, he or she is prompted to start over and retry playing the game. However, the questions may not appear in the same order so that the individual when we playing the game does not anticipate the next question. If the question is answered correctly, the motivator character may appear on the screen to cheer the individual 3052. The individual 3052 can then continue playing the game and move to the next question, lesson, course or educational tier.

Although not described in detail, an individual 3052 may have a plurality of available options to customize the game and to learn about the game. For example, the individual 3052 may select from which golf hole to start, read the rules of the game, view progress and score of the current leaders in playing the same competitive campaign as the individual 3052 has entered, learn about the prizes that may be awarded to an individual 3052 for winning the current campaign, and/or learn about previous campaign leaders.

According to one embodiment, a trivia game for individuals with a Socializers archetype may include a display that shows an individual a topic of one or more questions, one or more questions and one or more indicators that visually convey to the individual his or her performance. For example, the display may include an indicator that shows to the individual the number of questions answered, the number of correct answers and the number of incorrect answers. The display may also include a timing element that shows the individual the elapsed time or the time remaining before an answer to the question must be provided. Furthermore, the display may show an individual his or her total experience points, the experience points gained or lost in answering the last question, and/or the experience points that will be gained or lost in answering the current or next question. The display may also include various controls such as touchscreen buttons for control of the game by the individual. The controls may be physical controls on a digital device. Audible signals may also be provided during game play to indicate to the individual any of the above-described operations. For example, a pleasant ringing sound may indicate a correct answer while a buzzing sound may indicate an incorrect answer.

Based on the above, a game associated with educational activities according to the disclosure may have a plurality of game challenges that provide an opportunity to either teach and individual 3052 new concepts and/or test the individual 3052 on the previously learned concepts. Each of the challenges may correspond to certain information and/or questions that are part of a knowledge domain that includes all of the information associated with the educational platform as described herein. The educational activities may increase an individual's problem solving skills, declarative and factual knowledge, conceptual knowledge, rule based knowledge, procedural knowledge, soft skills, affective knowledge, and psychomotor skills. Accordingly, the educational activities may include games that include one or more problem solving style games, declarative and factual knowledge style games, conceptual knowledge style games, rule based knowledge style games, procedural knowledge style games, soft skills style games, affective knowledge style games, and psychomotor skills games. The above noted different game styles (e.g., conceptual, rule based, etc.) represent the types of knowledge and skill presented to an individual and learned by the individual while playing one of the games described herein based on his or her archetype. For example, a person having an Achiever archetype may play the labyrinth golf game in a rule based style game. Accordingly, the individual may be presented with rule based knowledge in the form of video presentations, lectures, questions, quizzes, exams and/or other types of educational related information exchange while playing the labyrinth golf game. According to another example, a person having a Killer archetype may play the golf karting game in a procedural knowledge style game. Accordingly, the individual may be presented with procedural based knowledge in the form of video presentations, lectures, questions, quizzes, exams, and/or other types of educational related information exchange while playing the golf karting game.

The difficulty of the challenges in a game may directly correlate with the difficulty and/or the detail of the information presented to the individual 3052 playing the game and/or the difficulty of the questions presented to the individual 3052. However, the difficulty of the challenges in the game may not correlate with difficulty and/or to detail of the information presented to the individual 3052 playing the game and/or the difficulty of the questions presented to the individual 3052. Thus, by engaging in the progressive and gamified educational experiences according to the disclosure, an individual 3052 can progressively obtain and build upon knowledge associated with golf related brands, golf related products and fitting of golf equipment to customers in order to become an expert in fitting golf equipment.

The administrator of the educational platform 100 may have the option of customizing the educational platform 100 to meet its needs. For example, if the educational platform 100 is being used by sales associates of a sporting-goods retailer or a golf equipment retailer, the retailer may have the option to configure the educational platform 100 to meet its needs based on information that is specific to the retailer or the costs associated with operating the educational platform 100. For example, the retailer can customize the lessons, the courses and/or the educational tiers to only provide customize golf fitting training for the products that are marketed and sold by the retailer. Thus, the operator and/or the administrator of the educational platform 100 may have the option of customizing the educational platform 100 to meet its needs.

The gamified augmented reality educational activities may further include a golf social networking feature. The individuals 3050 may compete or interact in the augmented reality environment against one another. Alternatively, the individuals 3050 may work together to complete the augmented reality educational activities over a golf social network (e.g., one shown as 3000 in FIG. 12).

In one example individuals 3050 of the golf social network 3000 (e.g., FIG. 12, individuals 3052, 3054, 3056, and 3058) may each be accumulating points by completing educational activities and triggering events (e.g., FIG. 5 educational activities 440 and 460, and triggering events 450 and 470). The points accumulated may be associated with a ranking system for the individuals 3050, which is provided for individuals 3050 to access.

For example, the individuals 3050 may be provided access to a digital golf leaderboard display through the golf social network 3000. The digital golf leaderboard display may represent the ranking system associated with the individual's accrued points. Each individual 3050 (e.g., 3052, 3054, 3056, and 3058) may be ranked on the digital golf leaderboard display, and each individual 3050 may have remote access to view the digital golf leader board through a digital device. The digital golf leaderboard may facilitate a competitive gamified experience for individuals 3050 when they are progressing through educational platform 400.

Referring to FIG. 9, an example of a leader board 800 is shown. The leaderboard 800 may be in a table format and include a plurality of columns and rows. Each row may be associated with an individual. Thus, the first row may represent the leader board information for the individual accessing or viewing the leaderboard. The remaining rows may display a list of individuals in the order of rank based on experience points (shown in FIG. 9 as XP). Thus, the second row may show information about the highest ranking individual on the leaderboard and the last row may show information about the individual having the lowest ranking on the leaderboard. An individual viewing the leaderboard 800 can scroll through the list of players with, for example, a side scroll bar 802. According to the example of FIG. 9, the first column 804 may show the rank of each individual; the second column 806 may show the geographical location of the individual with a name of location, map of the location or a flag; the third column 808 may show the identity of the individual by a picture, avatar, or a symbol corresponding to the individual; the fourth column 810 may show the username, actual name, or other identification indicators for the individual; the fifth column 812 may show the completed level (i.e., successful completion of a lesson increases the level as described in detail herein) of the individual; and the sixth column 814 may show the individual's accumulated experience points. The leaderboard may include other information about the individual and/or the individual's performance in the game relative to other individuals on the leaderboard. The leaderboard may also include other information such as campaign time 816, which may show the amount of time left for any competition or campaign associate with the leaderboard to end, and award details 818 for the awards given to the top participants in the competition or campaign.

Referring to the virtual campus as described above, the leaderboard may be accessible by an individual by visiting the social landmark 105. The individual can visit the social landmark 105 for checking the scores on the leaderboard, his position on the leaderboard, and/or to socialize with other individuals on the leaderboard by any method of communication, such as voice over IP, video conferencing, texting, email, chatting, blogging, using one or more forums or the like. The individual may also socially connect with others using social networks such as Facebook® of Palo Alto, Calif.

For example, the individual 3052 may challenge another individual (e.g., individuals 3054, 3056, or 3058) when playing the augmented reality fitting experience or find-it games. The individuals 3050 may compete in head-to-head competitions over a golf social network (e.g., one shown as 3000 in FIG. 12). Alternatively, the individual 3052 may challenge the individual 3054 by creating a custom augmented reality fitting experience or find-it game for the individual 3054 to complete. When the augmented reality educational activities are completed an activity metric (e.g., block 360 of FIG. 4) may be associated with the individual's (i.e., 3052 and 3054) performance.

The individual 3052 may also play other individuals by participating in a campaign that may be sponsored by a retailer, a manufacturer, and/or other organizations. The campaign may award the individual who is at the top of the leaderboard by the end of the campaign. Accordingly, participants in the campaign engage in the educational activities as described herein to accumulate experience points and badges. The winner of the campaign may be determined based on the number of experience points and/or the number of badges. For example, a campaign may recognize the top person on the leaderboard at the end of the campaign as the “fitter of the year” and reward that person with prizes, monetary rewards, or the like. Thus, competitions and/or limited duration campaigns may be used to encourage individuals to engage in the educational activities provided by the educational platform 100.

In some embodiments of the educational platform 100, the golf fitting expertise level (e.g., block 230 of FIG. 2) may be represented by an augmented reality indicia viewable through a digital device. The augmented reality indicia may be a badge associated with the golf fitting expertise level of the individual 3052, the activity metric, or the triggering event (identifying an accomplishment of the individual 3052 such as completing a particular trigger event, achieving a particular activity metric, and/or reaching a particular golf fitting expertise level). Further, the augmented reality indicia may be viewable through a social network feature of the educational platform 100. For example, a plurality of individuals 3050 may access the augmented reality indicia through the social venue landmark 105 (e.g., via a social network 3000 of FIG. 12).

In some embodiments of the educational platform 100, the individuals 3050 may be provided access to an avatar in the golf social network 3000. Individuals 3050 may access the various landmarks of educational platform 100 with an avatar. For example, individual 3052 may access the social venue landmark 105 in educational platform 100 with an avatar. While in the social venue landmark 105, individual 3052 may interact with other avatars associated with other individuals 3050 in the golf social network 3000 (e.g. 3054, 3056, or 3058).

When individual 3052 completes a particular triggering event, achieves a particular activity metric, and/or reaches a particular golf fitting expertise level the avatar may be given digital goods. For example when an individual 3052 completes an educational tier (e.g., FIG. 5 educational tier 410), the avatar may be given a new appearance, new digital equipment, or new digital badge associated with individual's 3052 accomplishment.

As described above, the educational platform is accessible by an individual through digital device. An individual can engage in courses and lessons of multiple educational tiers by accessing the virtual campus as described herein. During the individual's engagement with the educational activities described herein, however, the individual's learning experience is gamified through various games that are played in one or more simulated environments or worlds. Thus, the educational platform as described herein may include to simulated environments, with one being the virtual campus and other being the simulated environment in which educational games are played. The virtual environment in which the educational games are played may be simulated as a virtual world having simulated landscapes, buildings, avatars or characters, wild life, natural disasters, and/or other simulated objects and/or events that may be encountered in the real world. An individual's engagement with the virtual campus and the virtual environment may be experience as a journey during which the individual increases his knowledge and skills associated with golf fitting. All of the gamified educational activities of the educational platform may be experienced in the virtual world.

Regardless of the educational activity in which the individual is engaged, the individual may have access to all of the options and controls for the educational platform 100. For example, regardless of the display which the individual is feeling, he or she can access command menus to return to the virtual campus, view and/or edit his or her individual profile, viewed the leaderboard, log out of the educational platform 100, or any other control that may be available to the individual while engaged in educational platform 100.

An individual engaging the educational platform 100 to increase his or her golf fitting expertise may also learn about the rules of golf. Referring back to FIG. 1, the education platform 100 may also provide an individual with educational activities associated with rules of golf by activating a “rules of golf” module of the educational platform 100 or visiting the rules of golf landmark 195. As described in detail herein, visiting the rules of golf landmark 195 may entail an individual visiting the virtual campus and navigating to a building that is associated with the rules of golf. The building may be also associated with other educational activities. Accordingly, the individual may engage in educational activities associated with rules of golf by entering the building and interacting with objects and displays inside the building as described in detail herein. Alternatively, an individual may engage in educational activities associated with rules of golf by selecting one or more icons or buttons on a display of a digital device.

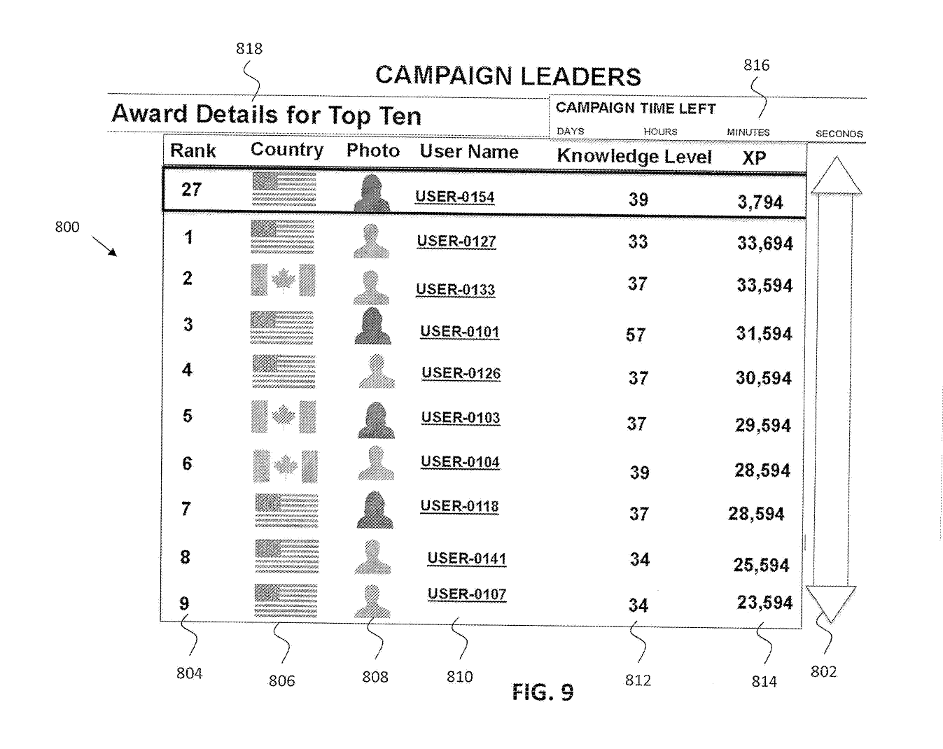

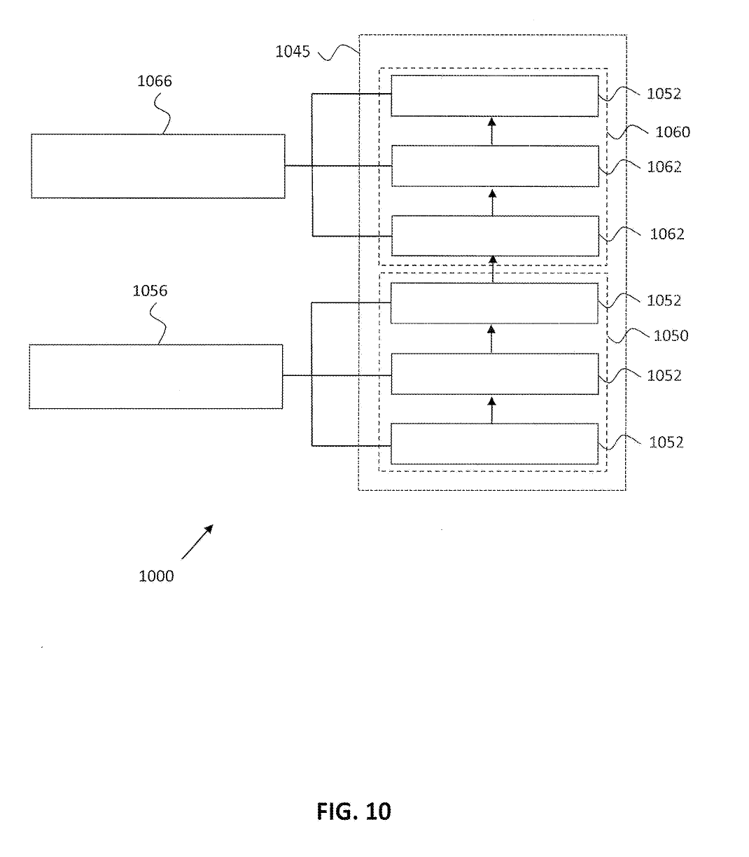

According to another embodiment shown in FIG. 10, an educational platform 1000 can be provided for teaching an individual the rules of golf. The educational platform 1000 may include at least two educational tiers 1050 and 1060. The educational platform 1000 may include additional educational tiers (not shown). Each of the educational tiers 1050 and 1060 may include a plurality of courses 1052 and 1062, respectively, with each course having a plurality of lessons (not shown). An individual engaging the educational activities of the educational platform 1000 can progressively increase his or her knowledge of the rules of golf by gamification as described in detail herein. The educational platform 1000 includes a database of information or a domain of knowledge 1045 from which courses and or lessons obtain educational material and/or information to increase an individual's knowledge with respect to the rules of golf. An individual's knowledge may include the specific areas of knowledge described in detail herein. Each of the educational tiers, the courses and/or the lessons of the educational platform may include gamified educational activities that increase an individual's knowledge with respect to the rules of golf. The rules of golf as described herein may refer to the rules of golf according to any golf governing body. In the following, however, the United States Golf Association (USGA) Rules and Decisions are used as examples to describe the educational platform 1000. The USGA Rules and Decisions include Sections I-III, Appendices and an Index. Each rule section has a rule section number and rule title. Section I, which is titled “Etiquette; Behavior on The Course” (also referred to herein as “the Etiquette section”) provides guidelines on the manner in which the game of golf should be played. The overriding principle of Section I is that consideration should be shown to others on the course at all times. Section II, which his titled “Definitions” (also referred to herein as “the Definition section”) covers definitions for the terminology used in the USGA Rules and Decisions. Section III covers the rules of the game of golf (also referred to herein as “the Rules of the Game section”). The Appendices cover local rules, design of clubs, the ball, other equipment, rules of amateur status, and USGA policy on gambling. The index provides a guide for finding certain rules and the application of those rules in Sections I-III and the Appendices.

A first educational tier 1050 may include courses 1052 that increase the knowledge of an individual 3052 with respect to declarative, factual and/or conceptual knowledge associated with the rules of golf. The first educational tier 1052 may include three courses 1052. The first course may be directed to the Etiquette section, the second course may be directed to the Definitions section, and the third course may be directed to recalling the rules in the Etiquette and Definitions sections according to rule number and rule title. Successfully completing each lesson and/or each course moves the individual up one level in the individual's knowledge with respect to the rules of golf. An individual 3052 who satisfactorily completes the first educational tier 1050 may become an expert with respect the Etiquette section and the Definitions section. The individual 3052 may then be awarded a first degree and/or a badge 1056.

The individual 3052 may then advance to the second educational tier 1060, which may include courses 1062 directed to the Rules of the Game section. The courses 1062 increase the rules based and procedural knowledge of the individual 3052 with respect to the rules of golf. The rules based and procedural knowledge may be based on the educational tier 1060 presenting the individual 3052 with simulated scenarios that require the individual to recall and apply the learned rules. The second educational tier 1060 may include three courses 1062. The first course may be directed to framing problems, which teach an individual 3052 to recall the questions needed to identify the facts of the simulated scenario. The second course may be directed to teaching an individual the procedures for using the Index to find rules that apply to certain scenarios and determine how to apply the rules to the certain scenario. The third course may be directed to presenting the individual with different simulated scenarios, where an individual 3052 learns to apply the correct ruling and perform the correct procedure for each particular scenario. An individual 3052 who satisfactorily completes the second educational tier 1060 may obtain a second degree and/or badge 1066. After an individual 3052 obtains a second degree, he or she can make a ruling to an issue that arises on the golf course.

The educational platform 1000 may include additional educational tiers such as a third educational tier (not shown). A third educational tier may include teaching an individual to make rulings in advanced or more complex scenarios than those presented to the individual in the second education tier 1060. The third educational tier may also include actual real time educational experience for the individual. For example, the individual may work as an intern or apprentice to golf professionals to further apply his or her skills from the first and second educational tiers to actual scenarios that require the application of the rules of golf. Upon completing the internship or apprenticeship, the individual may obtain a third degree and/or badge. In another example, the third educational tier may introduce the individual to the rules of golf from different golf governing bodies and the similarities and/or differences between the rules of golf among the different golf governing bodies.

Similar to the other embodiments described herein, the educational platform 1000 may be accessible by an individual 3052 with a digital device such as a desktop computer, laptop computers, handheld computer, tablet computer, portable media player (e.g., an IPOD® mobile digital device from Apple Inc., Cupertino, Calif.), wireless telephone (e.g., an IPHONE® mobile digital device from Apple Inc., Cupertino, Calif.), global positioning system (GPS) device, game console device, digital camera, video camera, and/or other processor-based device. When accessing the educational platform 1000, the individual 3052 is presented with the virtual campus similar to the other embodiments described herein, where each building represents a landmark associated with a certain educational activity or other activities associated with the educational platform 1000. The virtual campus for the educational platform 1000 may include, for example if the educational platform is directed to the USGA rules of golf, a building associated with the Etiquette section, a building associated with the Definitions section, a building associated with the Rules of the Game section, a building associated with the Appendices section and a building associated with the Index. Navigating through the virtual campus and through each building is described in detail herein with respect to other exemplary educational platforms and is not repeated for brevity. For example, each room in a building may correspond to the learning module of the particular section of the rules of golf or particular portion of Sections I, II and/or III. Thus, an individual can engage in educational activities associated with the educational platform 1000 by navigating through the virtual rooms of the virtual buildings of the virtual campus as described in detail herein.

An individual's experience with the educational platform 1000, learning through game unification, administering quizzes and exams to an individual upon completing a lesson, a course and/or an educational tier, and operation of the educational platform is described in detail herein and is not repeated for brevity. For example, the first educational tier 1050 may present an individual with gamified activities such as one or a plurality of role-playing games, fantasy or trilogy games, racing games, puzzles, sports games, shooting games, board games, trivia games, simulation, or any other virtual gaming experience. As described in detail herein, the types of games used in a gamified experience for each individual 3052 may be determined based on the archetype of the individual 3052 so that learning and information retention is maximized. After assessing and individual's archetype, the individual is presented with gamified educational experiences as described in detail herein based on his or her archetype. Thus, for example, the first educational tier 1050 provides an individual with gamified educational experiences based on his archetype, where the gamified experiences may be used for both teaching the individual the rules of golf and/or assessing the knowledge of the individual after completion of each lesson and/or course. For the second educational tier 1060, however, the gamified or simulated educational experiences and/or assessments of the individual may be based on the individual's performance and/or behavior in the first educational tier 1050.

As described in detail herein, the educational platforms according to the disclosure may include two simulated environments, with one being the virtual campus and other being the simulated environment in which educational games are played. An individual's engagement with the virtual campus and the virtual environment may be experienced as a journey during which the individual increases his knowledge and skills associated with the rules of golf. All of the gamified educational activities of the educational platforms according to the disclosure may be experienced in the virtual world.

The educational platform as described herein is not limited to golf related education, golf fitting or rules of golf. Referring to FIG. 11, an examplary educational platform 900 according to one embodiment is shown. The educational platform 900 includes an operational module 902 and a database module 904. The operational module 902 may include all hardware, software, communication and other operative components of the educational platform 900. Database module 904 includes educational data for use with the operational module 902. For example, the educational data stored in the database module 904 may be educational information associated with golf fitting as described in detail herein (e.g., domain of knowledge). In another example, the educational data stored in the database module 904 may be educational information associated with training sales associates for other sports or non-sports industries such as food service, clothing retail, automotive sales, home improvement services, etc. The educational data stored in the database module 904 may be educational information associated with one or more subjects for K-12 and/or university educational curriculums. Thus, the educational platform 900 may be used by any individual and/or organization by simply using a database module 904 that includes a certain educational information required by the individual and/or the organization.

Referring to FIG. 12, for example, a golf social network 3000 may include a computer network 3010, a server device 3020, a plurality of client devices 3030 (generally shown as 3032, 3034, 3036, and 3038), and a data storage device 3040. For example, the computer network 3010 may include a single computer, a telephone network (e.g., public switched telephone network (PSTN)), a personal area network (PAN), a local area network (LAN), a campus area network (CAN), a metropolitan area network (MAN), a wide area network (WAN), a virtual private network (VPN), a cable network, the Internet, any combination thereof, or other suitable types of network. The server device 3020 may be in communication with the plurality of client devices 3030 via the computer network 3010. For example, the plurality of client devices 3030 may include personal computers, laptop computers, handheld computers, tablet computers, portable media players (e.g., an IPOD® mobile digital device from Apple Inc., Cupertino, Calif.), wireless telephones (e.g., an IPHONE® mobile digital device from Apple Inc., Cupertino, Calif.), global positioning system (GPS) devices, game console devices, digital cameras, video cameras, and/or other processor-based devices. The plurality of client devices 3030 may operate on any operating system configured to support a browser or browser-enabled application to view a website and/or to execute a mobile application (e.g., a software application developed to operate on wireless devices such as smartphones, media players, and/or tablets). The plurality of client devices 3030 may be operatively coupled to the computer network 3010 via one or more wired or wireless communication links. While FIG. 12 may depict a particular number of client devices 3030, the methods, apparatus, systems, and articles of manufacture described herein may include more or less client devices. The methods, apparatus, systems, and articles of manufacture described herein are not limited this regard.

Further, the server 3020 may be in communication with the data storage device 3040. The data storage device 3040 may be one or more mass storage devices to store software and/or data including golf handicap information of a plurality of members 3050 of the golf social network 3000 as lists, tables, arrays, databases, any combination thereof, and/or any other suitable types of data structure. The data storage device 3040 may include one or more volatile and/or non-volatile memories such as floppy disks and drives, hard disk drives, compact disks and drives, digital versatile disks (DVD) drives, flash memory drives, solid-state drives, or any combination thereof. The data storage device 3040 may be a local storage device within the server 3020. Alternatively, the data storage device 3040 may be a physically separate storage device operatively coupled to or in communication with the server device 3020 via a computer network or other connections. While FIG. 12 may depict a single data storage device (e.g., one shown as 3040), the methods, apparatus, systems, and articles of manufacture described herein may include more mass storage devices.

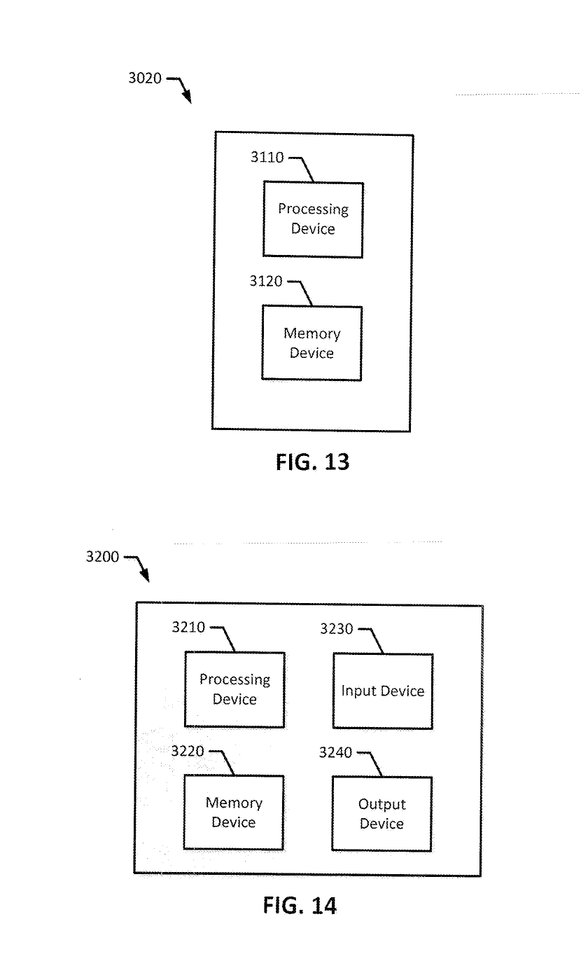

Turning to FIG. 13, for example, the server device 3020 may include a processing device 3110 and a memory device 3120. The processing device 3110 and the memory device 3120 may be operatively coupled to each other via one or more wireless or wired connections. The server device 3120 may be configured to identify members of the golf social network 3000 via the processing device 3110. The memory device 3120 may store software, firmware, and/or data. The methods, apparatus, systems, and articles of manufacture described herein are not limited in this regard.

In one example as illustrated in FIG. 14, a client device 3200 (e.g., one shown as 3032 in FIG. 6) may include a processing device 3210, a memory device 3220, an input device 3230, and an output device 3240. The processing device 3210, the memory device 3220, the input device 3230, and the output device 3240 may be operatively coupled to each other via one or more wireless or wired connections. The processing device 3210 may receive data and commands from the input device 3230 entered by the individual 3052 (e.g., a member of the plurality of members 3050 of FIG. 12). For example, the input device 3230 may be implemented by a keyboard, a mouse, a touch-sensitive display, a track pad, a track ball, a voice recognition system, and/or other suitable human interface device (HID). For example, the member 3052 (FIG. 6) may input equipment rating via the input device 3230. The output device 3240 may generate golf handicap information. For example, the output device 3240 may be implemented by display devices (e.g., a light emitting display (LED), a liquid crystal display (LCD), a cathode ray tube (CRT) display, a printer and/or a speaker). Further, the client device 3200 may also include other sensors and/or components to detect and provide location information and/or weather information associated with golf courses. The client device 3200 may be a personal computer, a laptop computer, a handheld computer, a tablet computer, a portable media player, a wireless telephone (e.g., a smartphone), a GPS device, a game console device, a digital camera, a video camera, and/or other processor-based devices. The methods, apparatus, systems, and articles of manufacture described herein are not limited in this regard.

While the above example may describe the golf social network 3200 in connection with golf handicap information, the golf social network 3200 may also provide an on-line community to promote and facilitate involvement of its members to communicate other golf-related information. For example, the plurality of members 3250 (FIG. 8) may meet and play golf with new people via the golf social network 3200, discuss and exchange ideas related to rules for golf equipment, provide reviews on golf equipment and courses, etc. The methods, apparatus, systems, and articles of manufacture described herein are not limited in this regard.

Although certain example methods, apparatus, systems, and articles of manufacture have been described herein, the scope of coverage of this disclosure is not limited thereto. On the contrary, this disclosure covers all methods, apparatus, systems, and articles of manufacture fairly falling within the scope of the appended claims either literally or under the doctrine of equivalents.

1. A method of training an individual for rules of golf comprising:
providing access to an educational platform having a plurality of educational tiers associated with rules of golf expertise levels, each educational tier having a plurality of educational activities associated with rules of golf;
associating an activity metric with at least one of the plurality of educational activities; and
identifying a rules of golf expertise level of rules of golf expertise levels based on the activity metric.

2. A method as defined in claim 1, wherein providing access to the educational platform comprises providing access to an educational tier having at least one game corresponding to an archetype of an individual having access to the educational platform.

3. A method as defined in claim 1, wherein providing access to the educational platform comprises providing an educational tier having at least one of a declarative style game, a conceptual style game, a rules-based knowledge style game, a procedural style game, an affective style game, a psychomotor game, or a soft skills style game.

4. A method as defined in claim 1, wherein providing access to the educational platform comprises providing access to an educational tier based on one of the activity metric or a triggering event.

5. A method as defined in claim 1, wherein identifying the rules of golf expertise level comprises identifying at least one of a novice level, a competent level, a proficient level, an expert level, or a master level.

6. A method as defined in claim 1, wherein identifying the rules of golf expertise level comprises generating an augmented reality indicia associated with an activity metric.

7. A method as defined in claim 1, wherein at least one of the plurality of educational activities is one of a quiz, test, video, contest, exercise, instruction, or audio presentation.

8. A method as defined in claim 1, wherein associating an activity metric with at least one of the plurality of educational activities comprises associating an activity metric with at least one of a confidence metric, a characteristic time, or a performance rating for at least one of a plurality of educational activities.

9. A method as defined in claim 1, wherein providing access to the educational platform comprises providing an invitation to an individual comprising one of a post card, an email, a text message, a link, or a digital message.

10. A method as defined in claim 1, wherein at least one of the plurality of educational activities comprises a gamified user interface associated with a virtual journey and virtual landmarks.

11. A method as defined in claim 1, wherein providing access to the educational platform comprises providing access to feedback associated with an educational activity.

12. A method as defined in claim 1, wherein providing an individual access to an educational platform comprises providing access to a knowledge bank comprising relevant information associated with the plurality of educational activities.

13. The method of claim 1, wherein the plurality of educational activities comprise:
at least a first educational activity and a second educational activity level, wherein the second educational activity is proportionate to the first educational activity.

14. The method of claim 1, wherein providing access to an educational platform comprises providing a virtual exercise for applying rules of golf.

15. A method of training an individual for rules of golf comprising:
providing access to an educational platform having a plurality of educational associated with rules of golf expertise levels, each educational tier having a plurality of educational activities associated with rules of golf comprising:
providing access to a first educational rules of golf tier comprised of providing at least one of a declarative style game or a conceptual style game, and
providing access to a second educational rules of golf tier comprised of providing at least one of a rules-based knowledge style game or a procedural style game; and
associating at least one activity metric with at least one of the plurality of education activities; and
identifying a rules of golf expertise level of the plurality of golf fitting expertise levels based on the activity metric.

16. The method of claim 15, wherein associating an activity metric with at least one of the plurality of educational activities comprises generating an augmented reality indicia associated with the activity metric.

17. A method as defined in claim 15, wherein associating an activity metric with at least one of the plurality of educational activities comprises associating an activity metric with at least one of a confidence metric, a characteristic time, or a performance rating for at least one of a plurality of educational activities.

18. A system comprising:
a server device in communication with a plurality of client devices via a computer network, the server device being configured to provide access to an educational platform; and
a data storage device operatively coupled to the server device, the data storage device having a plurality of educational tiers associated with rules of golf expertise levels, each educational tier having a plurality of educational activities associated with rules of golf, wherein the server device is configured to associate an activity metric with at least one of the plurality of educational activities, and to identify a rules of golf expertise level of the rules of golf expertise levels based on the activity metric.

19. (canceled)
